(19) United States
(12) Patent Application Publication
(10) Pub. No.: US 2024/0243328 A1
(43) Pub. Date: Jul. 18, 2024

(54) SYSTEMS AND METHODS FOR MAINTAINING ELECTROLYTE HEALTH

(71) Applicant: ESS TECH, INC., Wilsonville, OR (US)

(72) Inventors: Joseph Brindle, Tigard, OR (US); Sean Kissick, Portland, OR (US); Timothy J McDonald, Portland, OR (US); Yang Song, Durham, NC (US)

(21) Appl. No.: 18/409,691

(22) Filed: Jan. 10, 2024

Related U.S. Application Data
(60) Provisional application No. 63/480,439, filed on Jan. 18, 2023.

(51) Int. Cl. H01M 8/18; H01M 16/00

(52) U.S. Cl. CPC H01M 8/188; H01M 16/006

(57) ABSTRACT

Systems and methods are provided for maintaining electrolyte health of a redox flow battery system. The redox flow battery system comprising a redox flow battery cell having a positive electrode compartment and a negative electrolyte compartment, an electrolyte storage tank storing positive and negative electrolyte, the positive and negative electrolyte circulated between the electrolyte storage tank and respective positive and negative electrode compartments. The redox flow battery system further comprises a rebalancing battery including a positive electrode arranged in a flow path of the positive electrolyte and a negative electrode arranged in a flow path of the negative electrolyte.

### CROSS-REFERENCE TO RELATED APPLICATIONS

The present application claims priority to U.S. Provisional Application No. 63/480,439 entitled SYSTEMS AND METHODS FOR MAINTAINING ELECTROLYTE HEALTH filed Jan. 18, 2023. The entire contents of the above identified application is hereby incorporated by reference for all purposes.

### FIELD

The present description relates generally to maintaining electrolyte health in an iron redox flow battery system.

### BACKGROUND AND SUMMARY

Redox flow batteries are suitable for grid-scale storage applications due to their capability for scaling power and capacity independently, as well as for charging and discharging over thousands of cycles with reduced performance losses in comparison to conventional battery technologies. An all-iron hybrid redox flow battery is particularly attractive due to incorporation of low-cost, carth-abundant materials. In general, iron redox flow batteries (IFBs) rely on iron, salt, and water for electrolyte, thus including simple, earth-abundant, and inexpensive materials, eliminating incorporation of harsh chemicals and reducing an environmental footprint thereof.

Capacity degradation is a costly problem plaguing operation of batteries. In an IFB, capacity degradation may result from ferric (Fe³⁺) crossover from a positive electrolyte side of the IFB to a negative electrolyte side of the IFB. Ferric crossover to the negative electrolyte may result in precipitation of ferric hydroxides due to the higher pH of the negative electrolyte. Ferric hydroxide precipitates may accumulate on the negative electrode and membrane as well as passageways of the IFB, leading to lower battery performance and potential degradation of components. Additionally, ferric ions crossing through the IFB membrane may also transport water molecules through a process of osmotic drag. Through osmotic drag, as well as transport due to osmotic pressure gradients, water may accumulate on one half cell side of the IFB. This change in volume may cause changes in pH and concentration of the electrolytes, resulting in loss of battery capacity.

Ferric crossover may be addressed by use of rebalancing systems (e.g., rebalancing cells and rebalancing reactors) which may reduce ferric iron to ferrous iron (Fe²⁺) with hydrogen gas on the surface of a metal catalyst. Electrolyte imbalance may be addressed by mixing the high volume electrolyte with the lower volume electrolyte. Mixing may occur via one or more of bulk mixing when the IFB is in a discharged state, intermittent opening and closing of a mixing valve fluidly coupling the negative and positive electrolyte tanks to mix the electrolytes over intervals of time, and passive overflow through a spillover hole positioned at a top of a partition between the negative and positive electrolytes in a multi-chambered electrolyte tank.

However, the inventors herein have recognized issues with the above systems. Rebalancing reactors may be costly to install and operate due to use of precious metal catalysts which demand frequent maintenance and/or replacement to maintain desired performance levels. Further, mixing of electrolytes may demand the battery first reaching a nearly fully discharged state and may also further exacerbate ferric crossover.

In one example, the issues described above may be at least partially addressed by an iron battery coupled to a redox flow battery system, comprising: a redox flow battery cell having a positive electrode compartment and a negative electrode compartment, an electrolyte storage tank storing a positive electrolyte and a negative electrolyte, the positive electrolyte circulated between the positive electrode compartment and the electrolyte storage tank and the negative electrolyte circulated between the negative electrode compartment and the electrolyte storage tank, and a rebalancing battery including a positive electrode arranged in a flow path of the positive electrolyte and a negative electrode arranged in a flow path of the negative electrolyte.

In this way, a single system may address both volume balance of electrolytes and ferric crossover. Further, by reducing ferric crossover via an applied potential, use of an expensive catalyst may be avoided. Additionally, the rebalancing battery may be operated independently of whether or not the redox flow battery is in a fully discharged state.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including a rebalancing battery.

FIG. 2 shows a plot of positive and negative electrolyte volume of as a function of state of charge of the redox flow battery system.

FIG. 3 shows an illustration of the rebalancing battery according to an exemplary embodiment.

FIG. 4A shows an illustration of the rebalancing battery coupled to the redox flow battery system in parallel to a redox flow battery cell.

FIG. 4B shows an illustration of the rebalancing battery coupled to the redox flow battery system in series with a redox flow battery cell.

FIG. 5 shows a flow diagram of an example of a method for operating the rebalancing battery.

FIG. 6 shows variations in operating parameters for a redox flow battery including a rebalancing battery.

### DETAILED DESCRIPTION

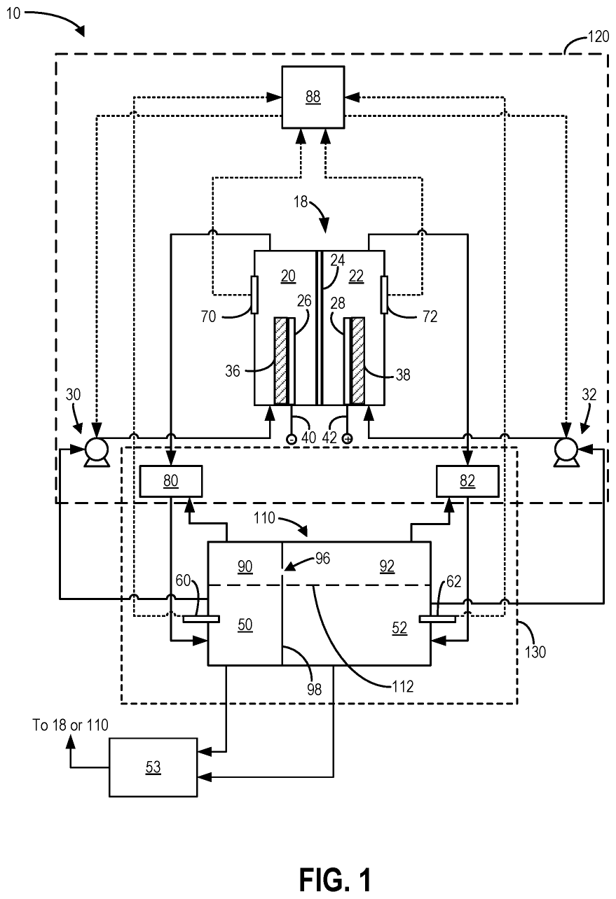

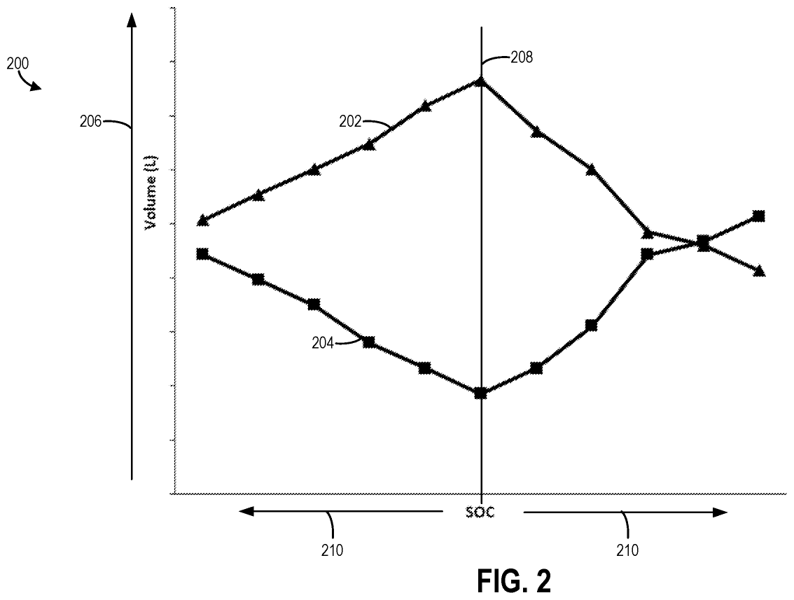

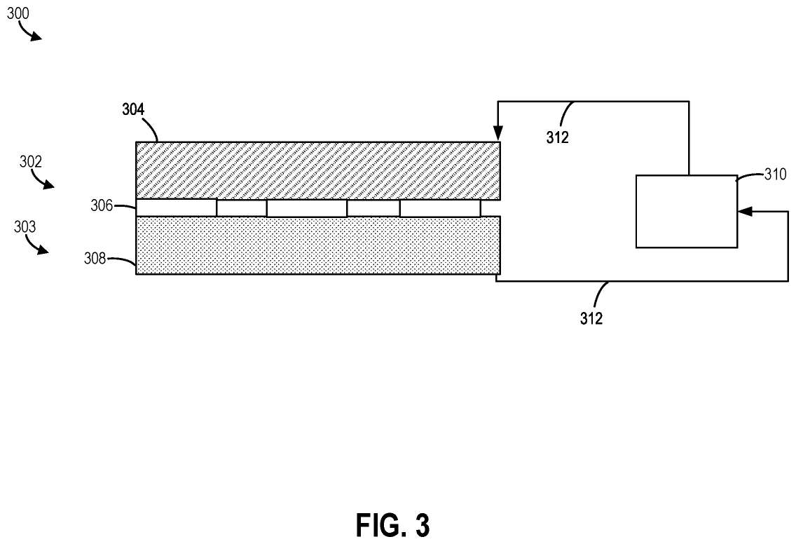

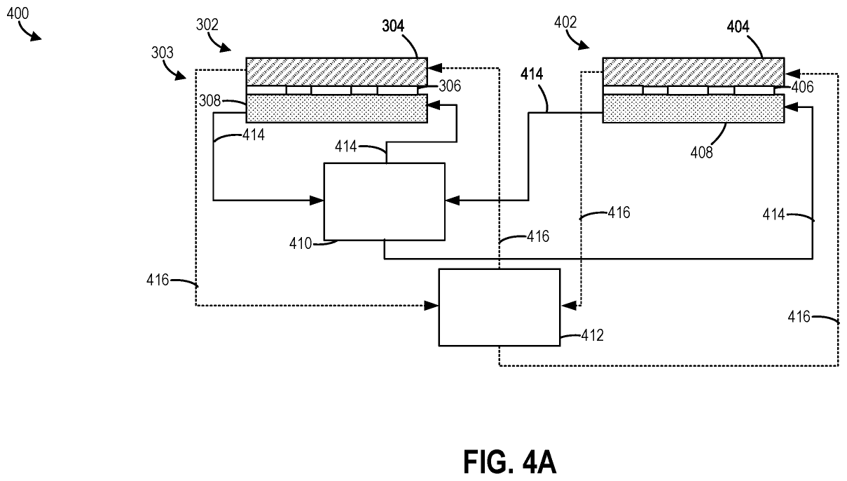

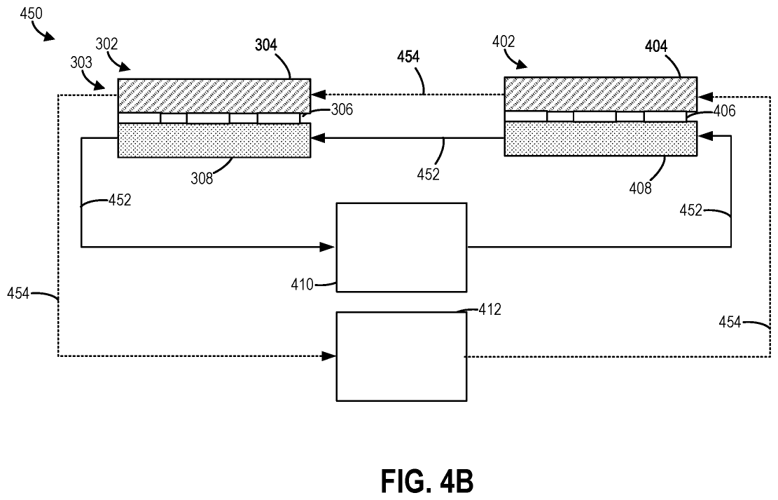

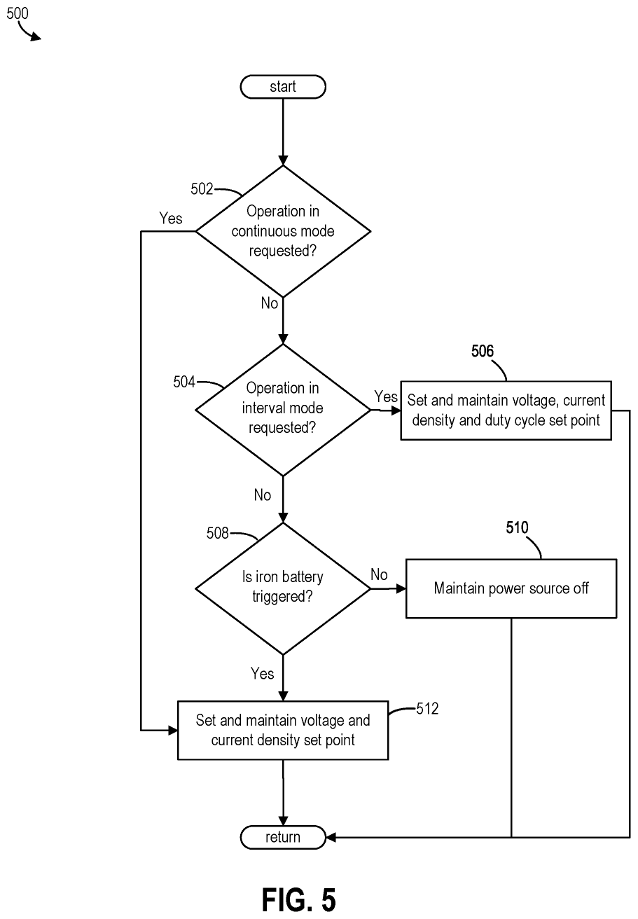

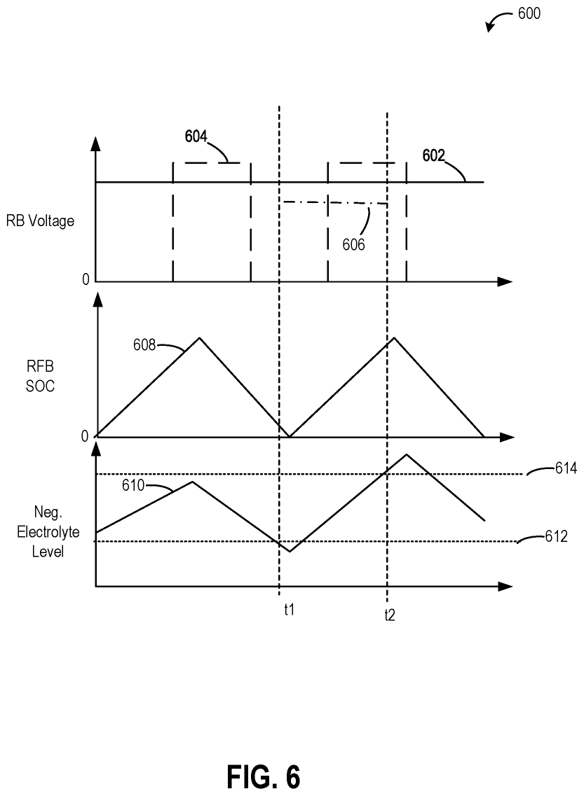

The following description relates to systems and methods for maintaining electrolyte health of a redox flow battery system, such as the redox flow battery system of FIG. 1. The volumes of negative and positive electrolytes at the start of operation of the redox flow battery system may be equal, but may become unbalanced over the course of a charging and discharging cycle as shown in FIG. 2. Electrolyte imbalance and ferric crossover may be addressed by a rebalancing battery, an example of which is illustrated in FIG. 3. The rebalancing battery may oxidize/reduce iron ions and may also be considered to be an iron battery, although herein referred to a rebalancing battery. The rebalancing battery may be coupled to the redox flow battery system in parallel as shown in FIG. 4A or in series as shown in FIG. 4B. An example of a method for operating the rebalancing battery is shown in FIG. 5. An example timing diagram showing operation modes of the rebalancing battery is shown in FIG. 6.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

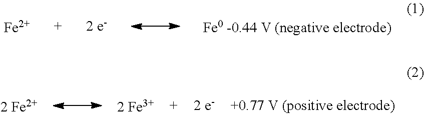

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. In some examples, electrolytes may also be balanced by a rebalancing battery 53 coupled to multi-chambered electrolyte storage tank. Rebalancing battery 53 may be an all-aqueous iron battery that is separate from and fluidically coupled to redox flow battery cell 18. Rebalancing battery 53 may be arranged in parallel or in series with redox flow battery cell 18. Rebalancing battery 53 may balance electrolytes without mixing the electrolytes, thereby mitigating loss of overall system efficiency in the process. Further details of rebalancing battery 53 are provided below, with reference to FIGS. 3-4B.

Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors 80 and 82. Rebalancing reactors 80 and 82 may also be herein referred to as rebalancing cells.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62. As examples, the one or more heaters may include coil type heaters or other immersion heaters immersed in the electrolyte fluid, or surface mantle type heaters that transfer heat conductively through the walls of the negative and positive electrolyte chambers 50 and 52 to heat the fluid therein. Other known types of tank heaters may be employed without departing from the scope of the present disclosure. Furthermore, the controller 88 may deactivate the one or more heaters in the negative and positive electrolyte chambers 50 and 52 in response to a liquid level decreasing below a solids fill threshold level. Said in another way, in some examples, the controller 88 may activate the one or more heaters in the negative and positive electrolyte chambers 50 and 52 only in response to a liquid level increasing above the solids fill threshold level. In this way, activating the one or more heaters without sufficient liquid in the negative and/or positive electrolyte chambers 50, 52 may be averted, thereby reducing a risk of overheating or burning out the heater(s).

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the rebalancing reactors 80 and 82 may include flow-through type reactors that are capable of contacting the H₂ gas and the electrolyte liquid and carrying out the electrolyte rebalancing reactions absent a packed catalyst bed.

In some examples, rebalancing reactors 80 and 82 may be replaced by rebalancing battery 53. In alternate examples, rebalancing reactors 80 and 82 may be supplemented by rebalancing battery 53. The rebalancing battery 53 may include a positive porous electrode, accepting positive electrolyte and a negative porous electrode accepting negative electrolyte. As described further below, an electric potential may be applied to rebalancing battery 53 thereby reducing ferric iron to ferrous iron and rebalancing the electrolyte charge imbalances without the use of a catalyst. In this way the expense and maintenance associated with of using a catalyst and regenerating catalytic activity may be avoided and/or minimized.

During operation of the redox flow battery system 10, sensors and probes may monitor and control chemical properties of the electrolyte such as electrolyte pH, concentration, SOC, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

For example, a sensor may be positioned in an external acid tank (not shown) to monitor acid volume or pH of the external acid tank, wherein acid from the external acid tank may be supplied via an external pump (not shown) to the redox flow battery system 10 in order to reduce precipitate formation in the electrolytes. Additional external tanks and sensors may be installed for supplying other additives to the redox flow battery system 10. For example, various sensors including, temperature, conductivity, and level sensors of a field hydration system may transmit signals to the controller 88. Furthermore, the controller 88 may send signals to actuators such as valves and pumps of the field hydration system during hydration of the redox flow battery system 10. Sensor information may be transmitted to the controller 88 which may in turn actuate the pumps 30 and 32 to control electrolyte flow through the redox flow battery cell 18, or to perform other control functions, as an example. In this manner, the controller 88 may be responsive to one or a combination of sensors and probes.

The redox flow battery system 10 may further include a source of H₂ gas. In one example, the source of H₂ gas may include a separate dedicated hydrogen gas storage tank. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a mass flow meter or other flow controlling device (which may be controlled by the controller 88) may regulate flow of the H₂ gas from the integrated multi-chambered electrolyte storage tank 110. The integrated multi-chambered electrolyte storage tank 110 may supplement the H₂ gas generated in the redox flow battery system 10. For example, when gas leaks are detected in the redox flow battery system 10 or when a reduction reaction rate is too low at low hydrogen partial pressure, the H₂ gas may be supplied from the integrated multi-chambered electrolyte storage tank 110 in order to rebalance the SOC of the electroactive materials in the positive electrolyte and the negative electrolyte. As an example, the controller 88 may supply the H₂ gas from the integrated multi-chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, wherein the pH increases beyond a first threshold pH or decreases beyond a second threshold pH. In the case of an IFB, the controller 88 may supply additional H₂ gas to increase a rate of reduction of Fe³⁺ ions and a rate of production of protons, thereby reducing the pH of the positive electrolyte. Furthermore, the pH of the negative electrolyte may be lowered by hydrogen reduction of Fe³⁺ ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the risk of precipitation of Fe³⁺ ions (crossing over from the positive electrode compartment 22) as Fe(OH)₃.

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

The controller 88 may further execute control schemes based on an operating mode of the redox flow battery system 10. For example, and as discussed in detail below with reference to FIG. 5, the controller 88 may control electric potential applied to rebalancing battery 53. Rebalancing battery 53 may be fluidically coupled to redox flow battery cell 18 and applying an electric potential to rebalancing battery 53 may help decrease a concentration of Fe³⁺ in the negative electrolyte and balance volumes of the positive and negative electrolytes. Controlling the electric potential, as opposed to continuous operation, may moderate parasitic power loss caused by operation of the iron battery. As another example, the controller 88 may control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to improve a battery charge capacity during subsequent battery cycling (thus, the iron metal may be preformed for battery cycling). The controller 88 may further execute electrolyte rebalancing as discussed above to rid the redox flow battery system 10 of excess hydrogen gas and reduce Fe³⁺ ion concentration. In this way, preforming iron at the negative electrode 26 and running electrolyte rebalancing during the system conditioning may increase an overall capacity of the redox flow battery cell 18 during battery cycling by mitigating iron plating loss. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be that appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

As described above, rebalancing reactors may be responsible for correcting an imbalance of Fe²⁺ and Fe³⁺ in the negative and positive electrolytes while a spillover hole of a multi-chambered electrolyte tank may be responsible for correcting a volume imbalance between the electrolytes. However, the rebalancing reactors may demand use of a precious metal catalyst which may demand frequent maintenance due to surface fouling or corrosion during operation of the rebalancing reactor. Further, the passive electrolyte rebalancing occurring by electrolyte mixing through the spillover hole may result in loss of battery capacity. In one example, a rebalancing battery may both rebalance charges and volumes of the negative and positive electrolytes. By applying an electric current to the rebalancing battery the electric potential drives reduction of Fe³⁺ in the negative electrolyte to Fe²⁺, thereby use of an expensive catalyst demanded to reduce Fe³⁺ using hydrogen gas in rebalancing reactors (such as rebalancing reactors 80 and 82 of FIG. 1) may be avoided. Alternatively, if used in addition to rebalancing reactors, the rebalancing battery may prolong a lifetime of the rebalancing reactor catalyst. Additionally, the rebalancing battery may drive electrolyte crossover in a direction to rebalance electrolyte volumes without mixing electrolytes and thus avoiding a decrease in battery capacity.

Referring now to FIG. 2, it shows a plot 200 of electrolyte volume as a function of state of charge of a redox flow battery system, such as the redox flow battery system 10 of FIG. 1 during a charging/discharging cycle. An arrow 206 indicates a direction of increasing volume along the y-axis of plot 200. A line 208 corresponds to a maximum state of charge (SOC) of the electrolyte. Arrows 210 indicate a direction of decreasing SOC along the x-axis. Trace 202 of plot 200 corresponds to a volume of negative electrolyte. The volume of negative electrolyte may be the total volume of electrolyte present in a negative electrolyte side of a multi-chambered electrolyte storage tank, such as multi-chambered electrolyte storage tank 110 of FIG. 1. Trace 204 of plot 200 corresponds to a volume of positive electrolyte. Similarly, the volume of positive electrolyte may be the total volume of electrolyte present in a positive electrolyte side of the multi-chambered electrolyte storage tank.

As shown in plot 200, before charging, at the leftmost data point of trace 202 and trace 204, a volume of negative electrolyte may be slightly greater than a volume of positive electrolyte. During the course of charging, as the redox flow battery SOC increases to the maximum SOC at line 208, negative electrolyte volume (e.g., trace 202) increases and positive electrolyte volume (e.g., trace 204) decreases due to osmotic pressure differences and osmotic drag from electrolyte species gradients resulting from Fe²⁺ removal from the negative electrolyte as it plates as Fe⁰. The negative electrolyte reaches a maximum volume and positive electrolyte reaches a minimum volume when the battery reaches its most charged state. During the course of discharging (to the right of line 208), as the redox flow battery SOC decreases, negative electrolyte volume decreases while positive electrolyte volume increases. When the redox flow battery system again reaches a fully discharged state, the positive electrolyte volume is greater than the negative electrolyte. Comparing the negative electrolyte volume when the redox flow battery is at the first completely discharged state with the volume of the negative electrolyte when the redox flow battery returns to the completely discharged state after a charging/discharging cycle, the negative electrolyte volume is decreased. The volume of the negative electrolyte has been lost to the positive electrolyte which was increased over the course of the charging/discharging cycle. In this way, a difference in negative and positive electrolyte volumes in the fully discharged state may become exaggerated over the course of many charging/discharging cycles.

The imbalance in electrolyte volumes may be remediated through operation of a rebalancing battery 302 shown in an illustration 300 of FIG. 3. In an exemplary embodiment, rebalancing battery 302 may be an iron battery and may be referred to as such herein. However, rebalancing other redox active species has been considered within the scope of this disclosure. Iron battery 302 may include one or more iron battery cells 303. In one embodiment a number of iron battery cells 303 included in iron battery 302 may be between 0 and 100. In an alternate embodiment, the number of iron battery cells 303 may be between 1 and 100. Each iron battery cell 303 may include a negative electrode 304 and a positive electrode 308, separated by a membrane 306. Each iron battery cell 303 of iron battery 302 may be electrically coupled to each other in series. Additionally, each iron battery cell 303 of the iron battery 302 may be fluidly coupled to each other in parallel.

Negative electrode 304 and positive electrode 308 may be formed of porous conductive materials such as, but not limited to, conductive carbon felt, graphene plates, and/or conductive polymer plates. Porous electrodes may promote high contact area between electrolyte and the electrode. Additionally, an electrode material may be selected to maximize a current density and potential of the power supplied to the electrolyte via the electrodes and to minimize an amount of materials used for constructing the electrodes. As one example, negative electrolyte may be flowed through pores of the negative electrode and positive electrolyte may be flowed through pores of the positive electrode. The iron battery may be differentiated from a redox battery cell, such as redox battery cell 18 of FIG. 1, by a lack of plating. The iron battery modifies a balance of Fe²⁺/Fe³⁺ in the negative and positive electrolyte, both of which are soluble in the all-aqueous iron battery. The all-aqueous iron battery may not include a catalyst formed of a precious metal or be coupled to a source of hydrogen gas. Additionally, the iron cations may be bound by solubilizing ligands. Further, iron battery 302 may be coupled to a power supply that is different from the power supply coupled to the redox flow battery cell. The iron battery may be shorted, thereby making it capable of remediating electrolytes (e.g., cleaning and/or balancing electrolyte volumes) after electrolyte use by the redox flow battery cell.

Iron battery 302 may further include a power source 310. Power source 310 may be electrically coupled to negative electrode 304 and positive electrode 308 of each battery cell 303 of iron battery 302. In one example, negative electrode 304 and positive electrode 308 may be coupled to power source 310 such that when an electric potential is applied, electrons flow from positive electrode 308 to negative electrode 304 in a direction indicated by arrows 312. In this way, Fe²⁺ in electrolyte passing through positive electrode 308 may be oxidized to Fe³⁺ and Fe³⁺ in electrolyte passing through negative electrode 304 may be reduced to Fe²⁺. The direction of current indicated by arrows 312 may be considered a charging mode of iron battery 302. In one example, the electric potential applied to a single iron battery cell 303 of iron battery 302 may be greater than 0.0 V and less than or equal to 1.2V. In an embodiment wherein iron battery 302 includes a plurality of iron battery cells 303 coupled in series, the maximum potential applied to iron battery 302 may be 1.2V multiplied by the number of iron battery cells 303 comprising iron battery 302. Further, the current density, when applying the electric potential, may be between 0 mA/cm² and 100 mA/cm². As a further example, current density may be 0.5 mA/cm².

Additionally, operating iron battery 302 in charging mode may as described above may induce an ionic flux from positive electrolyte to negative electrolyte. The ionic flux may drive transport of water from the positive electrolyte to the negative electrolyte via osmotic drag. Iron battery 302 may operate in charging mode regardless of whether a redox flow battery cell (such as redox flow battery cell 18 of FIG. 1) to which it is fluidically coupled is operating in charging, discharging or idle mode. In this way, action of the iron battery may counterbalance the movement of water from the positive electrolyte to the negative electrolyte that occurs in the redox flow battery cell.

Example illustrations of an iron flow battery system including both an iron battery 302 and an iron flow battery cell 402 are shown in FIGS. 4A and 4B. Iron flow battery cell 402 may be the same or similar to redox flow battery cell 18 of FIG. 1. Accordingly, iron flow battery cell 402 may include a negative electrode compartment 404 and a positive electrode compartment 408 separated by a separator 406. Iron battery 302 may be smaller than iron flow battery cell 402. In some examples, iron battery 302 may be sized proportional to 1/10^{th} the active area of iron flow battery cell 402. For example, iron battery 302 may be sized to 1.5 cm²/W while iron flow battery cell 402 may be sized to 15 cm²/W. Additionally or alternatively, iron battery 302 may be sized proportional to between 1/100^{th} and ½ the active area of iron flow battery cell 402. Iron flow battery cell 402 and iron battery 302 may each be fluidly coupled to a positive electrolyte tank 410 and a negative electrolyte tank 412. In some examples, positive electrolyte tank 410 and negative electrolyte tank 412 may be two chambers of a multi-chambered electrolyte storage tank such as multi-chambered electrolyte storage tank 110 of FIG. 1.

In one embodiment, as shown in illustration 400 of FIG. 4A, iron battery 302 and iron flow battery cell 402 may be fluidly coupled to positive electrolyte tank 410 and negative electrolyte tank 412 in a parallel fashion. Positive electrolyte may flow following a path depicted by arrows 414. From positive electrolyte tank 410, positive electrolyte may be input into positive electrode 308 of iron battery 302 and the positive electrolyte output from positive electrode 308 may be collected back into positive electrolyte tank 410. Concurrently, positive electrolyte may be input into positive electrode compartment 408 of iron flow battery cell 402 and may be output from positive electrode compartment 408 back to positive electrolyte tank 410. In a similar fashion, negative electrolyte may flow following a path depicted by arrows 416. From negative electrolyte tank 412, negative electrolyte may be input into negative electrode 304 of iron battery 302 and the negative electrolyte output from negative electrode 304 may be returned to negative electrolyte tank 412. Concurrently, negative electrolyte may be input into negative electrode compartment 404 of iron flow battery cell 402 and output from negative electrode compartment 404 back to negative electrolyte tank 412. In this way, electrolyte may be coupled to both the iron flow battery cell 402 and the iron battery 302. Fe³⁺ present in the negative electrolyte due to crossover from the positive electrolyte or due to side reactions may be reduced to Fe²⁺ and a chance of Fe(OH)₃ precipitation in the negative electrolyte may be reduced.

Turning now to FIG. 4B, an illustration 450 is shown of iron battery 302 and iron flow battery cell 402 fluidically coupled in series with, and downstream of iron flow battery cell 402. Positive electrolyte may flow as depicted by arrows 452. From positive electrolyte tank 410, positive electrolyte may flow first to positive electrode compartment 408 of iron flow battery cell 402. Positive electrolyte may then be output from positive electrode compartment 408 to input into positive electrode 308 of iron battery 302. The positive electrolyte may then be output from positive electrode 308 and flow back into positive electrolyte tank 410. Negative electrolyte flow may be depicted by arrows 452. From negative electrolyte tank 412, negative electrolyte may flow first to negative electrode compartment 404 of iron flow battery cell 402. Negative electrolyte may then be output from negative electrode compartment 404 to negative electrode 304 of iron battery 302. Negative electrolyte may then be output from negative electrode 304 and flow back to negative electrolyte tank 412. In this way, Fe³⁺ present in the negative electrolyte may be reduced to Fe²⁺ before being mixed into negative electrolyte tank 412.

In an alternate example, iron battery 302 may be coupled in series with, and upstream of iron flow battery cell 402. In such an example, directions of arrow 452 and arrow 454 may be reversed and electrolyte may in general flow from iron battery 302 to iron flow battery cell 402 before entering the electrolyte tank.

An iron battery, such as iron battery 302 of FIG. 3 may help to rebalance water from the positive electrolyte to the negative electrolyte when the iron battery is fluidically coupled to an iron flow battery cell such is iron flow battery cell 18 of FIG. 1, in parallel or in series as show in above in FIGS. 4A-B. Table 1 below shows volumes of positive electrolyte and negative electrolyte volumes after a single charging/discharging cycles in an iron flow battery system when the iron flow battery is fluidically coupled to an iron battery in either series or parallel.

TABLE 1
Volumes of positive and negative electrolyte observed after a single
cycle with an iron flow battery cell coupled to an iron battery

| Iron Battery | | | |
|---|---|---|---|
| Set Point (V) | Configuration | (+) mL | (−) mL |
| 0.6 | Series | 440 | 460 |
| 0.6 | Parallel | 424 | 440 |
| 0.3 | Parallel | 304 | 332 |
| 0.6 | Parallel | 484 | 492 |
| 0.9 | Parallel | 424 | 470 |

As opposed to when the iron flow battery is operated without being coupled to the iron battery, as described above with respect to FIG. 2, a negative electrolyte volume is greater than a positive electrolyte volume after several charging discharging cycles. The increase in negative electrolyte volume relative to the positive electrolyte occurs when the iron battery is coupled to the iron flow battery in both a series and parallel configuration.

Turning now to FIG. 5, an example of a method 500 for operating a redox flow battery system (such as redox flow battery system 10 of FIG. 1) including an iron battery fluidly coupled to the iron flow battery in series or in parallel as shown in FIGS. 3-4B is shown. In some examples, the iron battery may be operated in one of three operating modes: continuous, interval or triggered. Method 500 may be carried out via the controller 88 of FIG. 1 and may be stored as executable instructions at a non-transitory storage medium (e.g., memory) communicably coupled to controller 88. Method 500 may be executed upon activation of the redox flow battery system. For example, electrolyte flow may be driven and controlled by one or more pumps and valves and the battery system may be operating in a charging, discharging, or idling mode.

At 502, method 500 includes determining if the iron battery is to be operated in the continuous operating mode. In the continuous operating mode, power may be supplied to the iron battery for a duration that the iron flow battery is operating (e.g., in charging, discharging, or idle mode). If method 500 determines that the iron battery is to be operated in the continuous operating mode, method 500 continues to 512 and includes setting and maintaining a voltage and current density set point of a power source coupled to the iron battery (such as power source 310 of FIG. 3). In one example, the voltage may be set and maintained at a value between 0.1V and 1.0V per cell of the iron battery and current density may be set and maintained at a value between 0 and 100 mA/cm². Method 500 returns.

If at 502, the iron battery is not to be operated in continuous operating mode, then method 500 continues to 504 to determine if the iron battery is being operated in the interval operating mode. If the iron battery is being operated in the interval operating mode, method 500 continues to 506 to set and maintain a voltage and current density set point of the power source as described above with respect to 512. Method 500 further includes, at 506, setting and maintaining a duty cycle for which the set voltage and current densities may be applied. The duty cycle may describe an alternating duration for which the power source may be turned on and off. In other words, pre-set time intervals may be provided for energizing/de-energizing the iron battery. Method 500 returns.

If at 504, operation in the interval operating mode is not requested, then the iron battery is to be operated in the triggered operating mode. Method 500 continues to 508 to determine if the iron battery is triggered. As one example, triggering the iron battery may include indication, e.g., from a sensor monitoring electrolyte level, that an electrolyte level in an external negative electrolyte chamber is below a lower volume threshold level. Further, the iron battery may no longer be triggered when the sensor indicates that negative electrolyte volume is above an upper threshold. Additionally or alternatively, a sensor monitoring indications of Fe³⁺ concentrations in electrolytes, and/or pH values of positive or negative electrolytes of the iron flow battery system may be used to trigger applied voltage to the iron battery when the iron battery is operated in the triggered operating mode. If the iron battery is triggered, method 500 proceeds to 512 to set and maintain a voltage and current density at the power source as described above. Method 500 returns.

If at 508, the iron battery is not triggered, method 500 proceeds to 510 to maintain the power source in an off state. Method 500 returns. In this way, in the triggered state the iron battery may be powered when the health or volumetric balance of the electrolyte of the iron flow battery degrades and otherwise remain in an off state and a parasitic power used by the iron battery may be minimized.

Operation modes of a rebalancing battery are discussed further below with reference to timing diagram 600 shown in FIG. 6. The rebalancing battery may be an iron battery, such as iron battery 302 shown in FIGS. 3-4B. The rebalancing battery may be coupled to a redox flow battery cell as part of a redox flow battery system, such as redox flow battery system 10 of FIG. 1. As described above, the rebalancing battery may be fluidly coupled to the redox flow battery cell in series or in parallel. Additionally, the rebalancing battery may include a negative electrode and positive electrode coupled to a power source. The power source may be maintained at a set voltage and current density according to a selected operating mode of the rebalancing battery as described above with respect to the flow chart of FIG. 5.

A horizontal axis of diagram 600 denotes time and vertical markers t1 and t2 denote a time of events. Timing diagram 600 includes three plots. A vertical axis may show increasing values as denoted by labels of the vertical axis of each plot. A first plot corresponds to a voltage applied to the rebalancing battery (RB Voltage). Line 602 of the first plot shows a voltage applied to the rebalancing battery operating in the continuous operating mode, line 604 shows a voltage applied to the rebalancing battery operating in the interval operating mode, and line 606 shows a voltage applied to the rebalancing battery operating in the triggered operating mode. The voltage applied may be between 0.0 V and 1.0 V per battery cell of the rebalancing battery with a current density between 0 mA/cm² and 100 mA/cm² as described above. A second plot corresponds to SOC of the redox flow battery (RFB SOC), line 608 shows an SOC of the redox flow battery. Increasing SOC (positive slope of line 608) may indicate the redox flow battery system is operating in a charging mode and decreasing SOC (negative slope of line 608) may indicate the redox flow battery system is operating in discharging mode. A third plot corresponds to negative electrolyte level and line 610 shows a volume of negative electrolyte in the redox flow battery system. Line 612 shows a lower threshold of negative electrolyte volume and line 614 shows an upper threshold of negative electrolyte.

Prior to t1, the redox flow battery system may undergo charging followed by discharging, wherein the SOC increases to a maximum and decreases again as shown by line 608. Prior to t1, the rebalancing battery voltage may be maintained at a constant value when operating in the continuous operating mode, as shown by line 602. Over the same time period, the rebalancing battery operating in the interval operating mode may increase to a set voltage for a portion of the time prior to t1 as shown by line 604. The length of the portion of time may be set as a duty cycle of the interval operation mode. The set voltage in the interval operation mode shown by line 604 may be the same or different from the set voltage shown by line 602, but is shown at a different voltage here for clarity. Additionally, prior to t1, negative electrolyte volume as shown by line 610 may increase and decrease as the battery charges and discharges as described above with respect to FIG. 2. As one example, if negative electrolyte volume is being used as a trigger, prior to t1, the voltage of the rebalancing battery operated in the triggered operating mode may remain at 0.0 V because the negative electrolyte volume remains between the upper and lower threshold volume levels as shown by lines 614 and 612 respectively.

At t1, the negative electrolyte volume may be below the lower volume threshold, thereby triggering the rebalancing battery voltage to maintain a non-zero voltage as shown by line 606. In alternate embodiments, a trigger of the triggered operating mode may be an upper threshold of Fe³⁺ in the electrolyte, or the electrolyte pH being outside of upper or lower pH threshold limits. The voltage maintained at the rebalancing battery during operating in the triggered operating mode may be the same or different from the voltage maintained during operation in the continuous operating mode or the interval operating mode, but is shown here at a different voltage for clarity.

Between t1 and t2, the redox flow battery may continue to discharge and charge. The voltage applied at the rebalancing battery operating in the continuous operating mode and the interval operating mode may be same between t1 and t2 as prior to t1. The voltage applied at the rebalancing battery operating in the triggered operating mode may be maintained at a set voltage while the rebalancing remains triggered between tland t2.

At t2, the redox flow battery negative electrolyte shown by line 610 may be above the upper threshold electrolyte volume as shown by line 614, thereby de-triggering the rebalancing battery operating in the triggered operating mode. When the rebalancing battery is no longer triggered, as described above with respect to FIG. 5, the rebalancing battery operating in the triggered operating mode may switch the power source of the rebalancing battery off, thereby resulting in zero voltage applied to the rebalancing battery.

After t2, the redox flow battery may continue to charge and discharge. The voltage applied at the rebalancing battery operating in the continuous operating mode and the interval operating mode may be the same after t2 as between t1 and t2 and prior to t1. The voltage applied to the rebalancing battery operating in the triggered mode may remain de-triggered and a voltage applied to the rebalancing battery operating in triggered mode may be zero.

The technical effect of method 500 is that charge and volume imbalances within a redox flow battery system may be addressed, thereby increasing an efficiency and performance of the redox flow battery system by operation of a rebalancing battery fluidly coupled to a redox flow battery cell. Operation of the rebalancing battery may simply include continuous application of an electric potential across electrodes of the rebalancing battery. Alternatively, the rebalancing battery may be operated in a non-continuous fashion which may introduce more complexity but may minimize an amount of power consumed by the rebalancing battery.

In this way, an electrolyte health may be maintained during operation of an iron flow battery system. The iron battery may reduce Fe³⁺ to Fe²⁺ in the negative electrolyte and oxidize Fe²⁺ to Fe³⁺ in the positive electrolyte. In this way, Fe³⁺ crossover in the iron flow battery may be remediated. Further the iron battery may drive ions in a direction opposite to the ion cross over of the iron flow battery system. In this way, osmotic drag in an opposite direction may be driven by the iron battery and volumes of electrolyte on the negative and positive sides of the iron flow battery may be remediated.

The disclosure also provides support for a redox flow battery system, comprising: a redox flow battery cell having a positive electrode compartment and a negative electrode compartment, an electrolyte storage tank storing a positive electrolyte and a negative electrolyte, the positive electrolyte circulated between the positive electrode compartment and the electrolyte storage tank and the negative electrolyte circulated between the negative electrode compartment and the electrolyte storage tank, and a rebalancing battery including a positive electrode arranged in a flow path of the positive electrolyte and a negative electrode arranged in a flow path of the negative electrolyte. In a first example of the system, the rebalancing battery is an all-aqueous iron battery. In a second example of the system, optionally including the first example, the rebalancing battery is arranged in the flow paths of the positive and negative electrolytes parallel to the positive and negative electrode compartments of the redox flow battery cell. In a third example of the system, optionally including one or both of the first and second examples, the rebalancing battery is arranged in the flow paths of the positive and negative electrolytes in series with the positive and negative electrode compartments of the redox flow battery cell. In a fourth example of the system, optionally including one or more or each of the first through third examples, the rebalancing battery is arranged in the flow path of the positive and negative electrolytes upstream or downstream of the positive and negative electrode compartments of the redox flow battery cell. In a fifth example of the system, optionally including one or more or each of the first through fourth examples+ is reduced to Fe2+ at the negative electrode of the rebalancing battery, and wherein Fe2+ is oxidized to Fe3+ at the positive electrode of the rebalancing battery.

The disclosure also provides support for a method of operating a redox flow battery system, comprising, fluidly coupling a rebalancing battery to a redox flow battery cell, wherein the rebalancing battery includes one or more iron battery cells, and a power source, requesting an operating mode of the rebalancing battery, maintaining a set voltage and current density applied across negative and positive electrodes of the rebalancing battery by the power source according to the operating mode, and wherein maintaining the set voltage and current density reduces Fe3+ to Fe2+ at the negative electrode. In a first example of the method, the rebalancing battery is fluidly coupled to the redox flow battery cell in series or in parallel. In a second example of the method, optionally including the first example, the set voltage is between 0.0 V and less than or equal to 1.2 V for each iron battery cell of the one or more iron battery cells, and wherein the current density is greater than 0 mA/cm2 and less than 100 mA/cm2 for each iron battery cell of the one or more iron battery cells. In a third example of the method, optionally including one or both of the first and second examples, requesting the operating mode includes requesting continuous, interval, or triggered operating modes. In a fourth example of the method, optionally including one or more or each of the first through third examples, requesting the continuous operating mode includes maintaining the set voltage and current density for a duration of operation of the rebalancing battery. In a fifth example of the method, optionally including one or more or each of the first through fourth examples, requesting the interval operating mode includes selecting a duty cycle and applying the set voltage and current density at intervals according to the selected duty cycle. In a sixth example of the method, optionally including one or more or each of the first through fifth examples, requesting the triggered operating mode includes maintaining the set voltage and current density when triggered by a sensor of the redox flow battery system.

The disclosure also provides support for a redox flow battery system, comprising, a positive electrolyte and a negative electrolyte, a redox flow battery cell including a positive electrode compartment configured to receive the positive electrolyte and a negative electrode compartment configured to receive the negative electrolyte an iron battery fluidly coupled to the redox flow battery cell and including iron battery cells, and wherein each of the iron battery cells includes a negative electrode configured to receive the negative electrolyte, and a positive electrode configured to receive the positive electrolyte, and wherein the iron battery includes a power source configured to drive reduction at the negative electrode and oxidation at the positive electrode of each iron battery cell of the one or more iron battery cells. In a first example of the system, the negative and positive electrodes are porous and formed of conductive carbon felt, graphene plates and/or conductive polymer plates. In a second example of the system, optionally including the first example, reduction at the negative electrode and oxidation at the positive electrode induces osmotic drag of water from the positive electrolyte to the negative electrolyte. In a third example of the system, optionally including one or both of the first and second examples, the iron battery does not plate iron and does not demand a catalyst formed of a precious metal. In a fourth example of the system, optionally including one or more or each of the first through third examples, reduction of Fe3+ occurs at the negative electrode of the iron battery when the redox flow battery system is operating in charging mode or discharging mode. In a fifth example of the system, optionally including one or more or each of the first through fourth examples, the iron battery is sized proportional to 1/100th to ½ the active area the redox flow battery cell. In a sixth example of the system, optionally including one or more or each of the first through fifth examples, the iron battery cells includes between 0 and 100 battery cells, and wherein the iron battery cells are electrically coupled to each other in series and fluidly coupled to each other in parallel.

FIG. 1 shows example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A redox flow battery system, comprising:
a redox flow battery cell having a positive electrode compartment and a negative electrode compartment;
an electrolyte storage tank storing a positive electrolyte and a negative electrolyte, the positive electrolyte circulated between the positive electrode compartment and the electrolyte storage tank and the negative electrolyte circulated between the negative electrode compartment and the electrolyte storage tank; and
a rebalancing battery including a positive electrode arranged in a flow path of the positive electrolyte and a negative electrode arranged in a flow path of the negative electrolyte.

2. The redox flow battery system of claim 1, wherein the rebalancing battery is an all-aqueous iron battery.

3. The redox flow battery system of claim 1, wherein the rebalancing battery is arranged in the flow paths of the positive and negative electrolytes parallel to the positive and negative electrode compartments of the redox flow battery cell.

4. The redox flow battery system of claim 1, wherein the rebalancing battery is arranged in the flow paths of the positive and negative electrolytes in series with the positive and negative electrode compartments of the redox flow battery cell.

5. The redox flow battery system of claim 4, wherein the rebalancing battery is arranged in the flow path of the positive and negative electrolytes upstream or downstream of the positive and negative electrode compartments of the redox flow battery cell.

6. The redox flow battery system of claim 1, wherein Fe³⁺ is reduced to Fe²⁺ at the negative electrode of the rebalancing battery, and wherein Fe²⁺ is oxidized to Fe³⁺ at the positive electrode of the rebalancing battery.

7. A method of operating a redox flow battery system, comprising:
fluidly coupling a rebalancing battery to a redox flow battery cell, wherein the rebalancing battery includes one or more iron battery cells, and a power source;
requesting an operating mode of the rebalancing battery;
maintaining a set voltage and current density applied across negative and positive electrodes of the rebalancing battery by the power source according to the operating mode; and
wherein maintaining the set voltage and current density reduces Fe³⁺ to Fe²⁺ at the negative electrode.

8. The method of claim 7, wherein the rebalancing battery is fluidly coupled to the redox flow battery cell in series or in parallel.

9. The method of claim 7, wherein the set voltage is between 0.0 V and less than or equal to 1.2 V for each iron battery cell of the one or more iron battery cells, and wherein the current density is greater than 0 mA/cm² and less than 100 mA/cm² for each iron battery cell of the one or more iron battery cells.

10. The method of claim 7, wherein requesting the operating mode includes requesting one of continuous, interval, or triggered operating modes.

11. The method of claim 10, wherein requesting the continuous operating mode includes maintaining the set voltage and current density for a duration of operation of the rebalancing battery.

12. The method of claim 10, wherein requesting the interval operating mode includes selecting a duty cycle and applying the set voltage and current density at intervals according to the selected duty cycle.

13. The method of claim 10, wherein requesting the triggered operating mode includes maintaining the set voltage and current density when triggered by a sensor of the redox flow battery system.

14. A redox flow battery system, comprising:
a positive electrolyte and a negative electrolyte;
a redox flow battery cell including a positive electrode compartment configured to receive the positive electrolyte and a negative electrode compartment configured to receive the negative electrolyte;
an iron battery fluidly coupled to the redox flow battery cell and including iron battery cells, and wherein each of the iron battery cells includes a negative electrode configured to receive the negative electrolyte, and a positive electrode configured to receive the positive electrolyte; and
wherein the iron battery includes a power source configured to drive reduction at the negative electrode and oxidation at the positive electrode of each iron battery cell of the iron battery cells.

15. The redox flow battery system of claim 14, wherein the negative and positive electrodes are porous and formed of conductive carbon felt, graphene plates and/or conductive polymer plates, and wherein the iron battery does not plate iron and does not demand a catalyst formed of a precious metal.

16. The redox flow battery system of claim 14, wherein reduction at the negative electrode and oxidation at the positive electrode induces osmotic drag of water from the positive electrolyte to the negative electrolyte.

17. The redox flow battery system of claim 14, wherein reduction of Fe³⁺ occurs at the negative electrode of the iron battery when the redox flow battery system is operating in charging mode and/or discharging mode.

18. The redox flow battery system of claim 14, wherein the iron battery is sized proportional to 1/100^{th} to ½ the active area the redox flow battery cell.

19. The redox flow battery system of claim 14, wherein the iron battery includes between 0 and 100 battery cells.

20. The redox flow battery system of claim 14, wherein the iron battery cells are electrically coupled to each other in series and fluidly coupled to each other in parallel.
